(19) United States
(12) Patent Application Publication
(10) Pub. No.: US 2022/0341768 A1
(43) Pub. Date: Oct. 27, 2022

(54) LEVEL MEASUREMENT INSTRUMENT

(71) Applicant: JOHNSON MATTHEY PUBLIC LIMITED COMPANY, London (GB)

(72) Inventors: Graham BARKER, Billingham (GB); Simon LAMBERT, Billingham (GB); Carl Robert TIPTON, Billingham (GB)

(21) Appl. No.: 17/596,615

(22) PCT Filed: Aug. 11, 2020
(86) PCT No.: PCT/GB2020/051909

§ 371 Date: Dec. 14, 2021

(30) Foreign Application Priority Data
Sep. 4, 2019 (GB) 1912707.5

(51) Int. Cl. G01F 23/284

(52) U.S. Cl. CPC G01F 23/2845

(57) ABSTRACT

A level measurement instrument including: a transmitter configured to transmit an electromagnetic transmission signal, the electromagnetic transmission signal being a microwave signal or a radio wave signal a receiver configured to receive a plurality of electromagnetic return signals; an elongate electromagnetic radiation guide coupled to the transmitter to guide the electromagnetic transmission signal, wherein the elongate electromagnetic radiation guide is provided with a plurality of windows spaced along the elongate electromagnetic radiation guide, the windows being at least partially transmissive to the electromagnetic transmission signal such that in use, when the elongate electromagnetic radiation guide is introduced into a fluid column, the electromagnetic transmission signal interacts with fluid adjacent each window and generates electromagnetic return signals, the return signal from each window being dependent on a parameter of the fluid adjacent each window such that different fluids in the fluid column have different return signals.

### FIELD OF INVENTION

The present invention relates to a level measurement instrument for measuring the level of a fluid in a fluid column, and advantageously for measuring the level of multiple fluids in a multi-layered fluid column such as in an oil separator unit.

### BACKGROUND

The measurement of levels of fill, particularly of fluids including liquids, gases and fluid multi-phase materials such as emulsions and slurries, has been carried out for many years using nucleonic level gauges, by measuring the amount of radiation emitted by a radiation-source which is detected at one or more levels within the vessel. The radiation is attenuated as is passes through materials, the amounts of attenuation being related to the density of the materials between the source and a detector. By comparing the attenuation of radiation detected at different levels of the vessel, it is possible to estimate the height of materials contained in the vessel.

A density profiler based on these principles has been described in WO2000/022387. The device comprises a linear array of sources of ionising radiation which emit radiation towards detectors disposed in one or more linear arrays. When the source array and detector array(s) are positioned so that they traverse the interfaces between two or more fluids in a vessel, the interfaces of the fluids may be identified from the differences in radiation received by each detector in the array. The device has been successfully deployed for use in storage tanks and oil separators.

It may be undesirable to use a device which embodies a source of ionising radiation. In some parts of the world nucleonic technology may not be a viable option. Alternative detector arrangements with similar functionality that do not require a source of ionising radiation have accordingly been proposed.

Radar level gauge systems are known for measuring fluid levels in vessels. In particular, guided wave radar level sensor probes are known in which transmitted electromagnetic signals are guided towards and into the vessel by a wave guide, typically arranged vertically from top to bottom of the vessel. The electromagnetic signals are reflected at the fluid surface and received back at the level gauge system by a receiver. The time from emission to reception of the signals is used to determine the level in the vessel.

However, traditional guided wave radar solutions have limitations. For example, while guided wave solutions can detect a clean oil-water interface, they cannot detect an oil-water interface if there is an emulsion in the way. Furthermore, microwaves don't transmit through water and so don't probe effectively beyond a water interface.

It is an aim of the invention to provide a non-nucleonic measurement instrument for measuring levels of materials, especially of fluids, and optionally for measuring/calculating a level profile of a multi-layer fluid column, that mitigates some or all of the foregoing disadvantages of current guided wave radar solutions and/or offers an alternative functionality and/or enhanced accuracy.

### SUMMARY OF THE INVENTION

The present specification describes a level measurement instrument comprising:
a transmitter configured to transmit an electromagnetic transmission signal, the electromagnetic transmission signal being a microwave signal or a radio wave signal;
a receiver configured to receive a plurality of electromagnetic return signals;
an elongate electromagnetic radiation guide coupled to the transmitter to guide the electromagnetic transmission signal;
wherein the elongate electromagnetic radiation guide is provided with a plurality of windows spaced along the elongate electromagnetic radiation guide, the windows being at least partially transmissive to the electromagnetic transmission signal such that in use, when the elongate electromagnetic radiation guide is introduced into a fluid column, the electromagnetic transmission signal interacts with fluid adjacent each window and generates electromagnetic return signals, the return signal from each window being dependent on a parameter of the fluid adjacent each window such that different fluids in the fluid column have different return signals, and
wherein the receiver is configured to differentiate between the electromagnetic return signals and thus determine a level of one or more fluids in the fluid column based on a difference in relative permittivity of different fluids in the fluid column.

Also provided is a method of measuring a level of one or more fluids in a fluid column, the method comprising:
introducing the level measurement apparatus as described herein into the fluid column such that the elongate electromagnetic radiation guide extends through the fluid column,
transmitting an electromagnetic transmission signal, the electromagnetic transmission signal being a microwave signal or a radio wave signal, through the elongate electromagnetic radiation guide such that the electromagnetic transmission signal interacts with fluid adjacent each window and generates electromagnetic return signals, the electromagnetic return signal from each window being dependent on a parameter of the fluid adjacent each window such that different fluids in the fluid column have different return signals;
receiving the electromagnetic return signals; and
processing the return signals to differentiate between the electromagnetic return signals from each of the windows and determine a level of one or more fluids in the fluid column based on a difference in relative permittivity of different fluids in the fluid column.

Further still, a system is provided comprising a vessel for housing a fluid, and a level measurement instrument as described herein, the level measurement instrument being mounted such that the elongate electromagnetic radiation guide of the level measurement instrument extends through the vessel.

### DESCRIPTION OF THE DRAWINGS

The invention will now be described by way of example only with reference to the accompanying drawings, in which:

FIG. 1 shows a cutaway schematic of a level measuring instrument; and

FIG. 2 shows a schematic of a system configuration for a time-of-flight measurement system that can select the signal frequency from a range of available options.

### DETAILED DESCRIPTION

The present specification provides a level measurement instrument comprising a transmitter for transmitting an electromagnetic transmission signal and a receiver for receiving a plurality of electromagnetic return signals. The instrument further comprises an elongate electromagnetic radiation guide coupled to the transmitter and receiver to guide the electromagnetic transmission signal and the electromagnetic return signals in use. The elongate electromagnetic radiation guide is provided with a plurality of windows spaced along the elongate electromagnetic radiation guide, the windows being at least partially transmissive to the electromagnetic transmission signal such that in use, when the elongate electromagnetic radiation guide is introduced into a fluid column, the electromagnetic transmission signal interacts with fluid adjacent each window and generates electromagnetic return signals. The return signal from each window is dependent on a parameter (e.g. relative permittivity) of the fluid adjacent each window such that different fluids in the fluid column have different return signals. The receiver is configured to differentiate between the electromagnetic return signals and thus determine a level of one or more fluids in the fluid column.

The instrument is capable of profiling complex multi-layered fluid columns including oil/water interfaces and emulsions and may be found in an oil separator unit. As such, the instrument can provide a functional improvement over prior art radar level gauge systems, while also avoiding the use of nucleonic sources. One reason for the improved functionality is that the electromagnetic radiation is not directed through the fluid layers from above. Rather, the electromagnetic radiation is guided through the waveguide and only interacts with the fluid external to the elongate electromagnetic waveguide at defined vertical locations where the windows are provided in the waveguide. In this respect, the configuration is analogous to the provision of multiple nucleonic sources at defined vertical locations.

Another advantage of the present instrument is that it does not require the provision of multiple transmitters disposed at varying depths of the fluid column. The waveguide can direct electromagnetic radiation from a single transmitter along the elongate waveguide and the windows function to provide multiple interrogation points without the requirement of having individual transmitters. Similarly, the configuration does not require multiple receivers disposed at varying depths of the fluid column. The waveguide directs return signals from the plurality of windows along the waveguide such that a single receiver can be provided. This may be located in the same housing as the transmitter unit. That is, the transmitter and the receiver can be disposed in a housing at one end of the elongate electromagnetic radiation guide. As such, the present configuration provides a physically compact system with reduced component requirements.

The elongate electromagnetic radiation guide can be configured such that fluid does not enter the elongate electromagnetic radiation guide through the windows when the elongate electromagnetic radiation guide is introduced into a fluid column. For example, the elongate electromagnetic radiation guide can be formed of a tubular member (e.g. a metallic tubular member) through which the electromagnetic transmission signal and the electromagnetic return signals are guided in use, and the windows can be sealed by a solid transmission material (e.g. a glass or ceramic material, such as quartz for a microwave system) which is at least partially transparent to the electromagnetic transmission signal. The solid transmission material may be provided as individual window plates or as a tubular member located inside or outside the waveguide. Alternatively, the solid transmission material may partially or completely fill an interior of the elongate electromagnetic radiation guide.

In certain configurations, the windows are formed by slots in the elongate electromagnetic radiation guide thus providing a slotted wave guide. Slotted waveguides are known for use in other technology applications, but the applicant is not aware of any suggestion to use such slotted waveguides in a level measurement instrument as described herein.

In certain configurations, the transmitter is configured to transmit a microwave signal or a radio wave signal. The transmitter may be configured to transmit electromagnetic radiation having a frequency in a range 0.3 GHz to 300 GHz, preferably 2 GHz to 20 GHz, e.g. 2 GHz to 11 GHz or 2.4 GHz to 2.5 GHz.

The receiver is configured to differentiate between the electromagnetic return signals and thus determine a level of one or more fluids in the fluid column based on a difference in a parameter of the different fluids in the fluid column. The specific parameter which is utilized will depend on the type of electromagnetic radiation which is used and the types of fluids which are to be analyzed. For microwave-based instruments, a difference in relative permittivity of the fluids can be detected and used to determine the levels of each liquid.

The instrument as described herein can be used in a method of measuring a level of one or more fluids in a fluid column as follows.

The level measurement apparatus is introduced into a fluid column such that the elongate electromagnetic radiation guide extends through the fluid column. An electromagnetic transmission signal is then transmitted through the elongate electromagnetic radiation guide such that the electromagnetic transmission signal interacts with fluid adjacent each window and generates electromagnetic return signals. As previously described, the electromagnetic return signal from each window is dependent on one or more parameters of the fluid adjacent each window such that different fluids in the fluid column have different return signals. The return signals are then guided back to a receiver where they are processed to differentiate signals from each of the windows and determine a level of one or more fluids in the fluid column.

Accordingly, when the elongate electromagnetic radiation guide is inserted into a vessel from which level profile information is required, the transmitted signals are caused to undergo an interaction mediated by the material at each of the windows in the waveguide, being for example a material such as a fluid in a container, or the absence of such a material. For example, the transmitted signals may be caused to undergo an interaction mediated by the dielectric properties of the material at each of the windows. For example, the transmitted signals may be caused to pass through the material/fluid at the site and undergo an absorption and/or scattering interaction and/or the transmitted signals may be caused to be reflected by the material. As a result, a respective return signal may be produced for each window in the waveguide following such interaction mediated by the material at each of the windows. The return signals obtained from each of these multiple sites can then be processed to determine the dielectric properties (e.g. permittivity) of the material at each site/window. It is possible from this to draw inferences regarding the composition and/or levels of materials and/or the levels of any interface between materials.

Furthermore, while the instrument doesn't measure density directly, the instrument can be configured to calculate density and thus, for example, generate a density profile. In this regard, the instrument detects layers of different materials and thus detects layers of different density. The instrument can be pre-calibrated to convert the received signals into density values. Furthermore, it may be noted that for a water-oil emulsion, the mass density of water in oil will correlate with permittivity, at least to first order. As such, the instrument can be used to determine the density of emulsions in addition to water and oil layers.

The transmitter and receiver may be provided as a transceiver. The transmitter may include or be associated with a suitable signal generator for generating the electromagnetic signal. Alternatively, a separate transmitter and receiver may be provided.

In one configuration, a receiver may comprise a receiving array in which a plurality of receiving elements is provided, each receiving element disposed to receive a return signal corresponding to a respective transmitted signal from one of the said electromagnetic radiation emission sites. Such a receiving array may be remotely spaced from the window sites, e.g. at one end of the elongate waveguide. On certain configurations, a receiving array which is completely separate to the elongate waveguide may be provided. For example, the receiver may comprise an elongate receiving formation, discrete from the transmitted electromagnetic radiation guide, and provided with a receiving array having a plurality of receiving elements disposed along at least a portion of its elongate extent.

The instrument is preferably adapted to be inserted into a vessel so that the elongate electromagnetic radiation guide extends into the vessel, and into material/fluid contained therein, for example generally vertically from the top of the vessel. The instrument is thereby adapted for installation into a vessel containing a material at least a level of which needs to be determined.

It should be noted that the term fluid column as used herein is intended to include columns of material which may include one or more solid materials in addition to one or more fluid materials. Furthermore, the term fluid column is not intended to be limited to vertically oriented elongate vessels. The fluid column may be in a vertical or horizontal vessel. For example, in certain applications the instrument can be used in desalters and production separators, which are mainly horizontal vessels.

The provision of multiple electromagnetic radiation window/detection sites in a longitudinally spaced array along the elongate extent of the electromagnetic radiation guide means that the instrument is particularly adapted for measuring/calculating a profile of a mixed material system such as a mixed fluid system comprising two or more substances of different density and different dielectric properties. For example, the instrument is adapted for use in association with and installation into a vessel containing a layered/stratified material composition including at least a first substance having a first density, and a second substance having a second density different from the first density, whereby the instrument is adapted, and where installed in the vessel is suitably disposed, to determine a level of an interface between the first substance and the second substance.

Furthermore, for example, the instrument can be adapted for use in association with and installation into a vessel containing a layered/stratified material composition including at least a first substance having a first density, a second substance having a second density greater than the first density, and a third substance having a third density greater than the second density, whereby the instrument is adapted, and where installed in the vessel is suitably disposed, to determine a level of an interface between the first substance and the second substance and a level of an interface between the second substance and the third substance.

The substance or substances to be measured are not limited to any particular material phase, and may thus include solids, liquids and gases. Some examples of substances to which the instrument of the invention could be applied include without limitation petroleum products and other produced chemical products, water, sludge/sand and the like.

The invention may however find particular application in the measurement of levels of a vessel comprising plural stratified immiscible fluid phases and additionally at least one solid phase. A particular example of such a combination of phases to which the invention may be applied might be a vessel comprising an oil phase, an aqueous phase, and an air or other gas phase. Such materials will exhibit different dielectric properties. As such, the transmitted signal will interact differently depending on the material present at each window in the waveguide thereby providing an array of detection sites. Consequent differences in the received return signals allows inferences to be drawn about the respective phases and/or their levels.

The electromagnetic radiation guide may comprise at least one material having a relative permittivity less than that of water. Suitable materials may have a relative permittivity less than 10. The at least one material may have a relative permittivity less than 5. Low permittivity materials are suitable for use as microwave transmission windows and/or for provision through the core of the waveguide. The electromagnetic radiation guide may also comprise a suitable conductor. For example, the electromagnetic radiation guide may be formed of a metallic tubing which functions to constrain and guide the electromagnetic radiation.

The electromagnetic radiation guide may be substantially annular and for example may comprise an elongate hollow member such as a tube having a cross section which is square, rectangular, or rounded, e.g. circular or elliptical. The elongate tube is preferably a closed tube save for the windows/slots spaced along at least a portion of its elongate extent to constitute an array of detection sites.

To prevent ingress of the vessel contents during use, the interior of such an annular and/or hollow electromagnetic radiation guide may be filled with a solid fill material of a dielectric medium, and preferably one that is substantially transparent to the electromagnetic radiation to be guided by the electromagnetic radiation guide in use. For example, in the case where the electromagnetic radiation is microwave radiation, the electromagnetic radiation guide may be filled with a substantially microwave-transparent fill material. A suitable fill material may include a ceramic material.

The instrument of the invention conveniently comprises a head portion adapted in use to seat outside a vessel and an elongate probe portion adapted in use to extend into a vessel and into material contained therein. The elongate probe portion includes the elongate electromagnetic transmitted radiation guide.

Optionally, the probe portion may additionally comprise the receiver, and the transmitted electromagnetic radiation guide may additionally serve as a means to guide return electromagnetic radiation.

Alternatively, the receiver may be provided separate from the probe portion including the elongate electromagnetic radiation guide, for example in a second probe portion adapted in use to extend into a vessel and into material contained therein, for example being spaced from the first probe portion to receive return electromagnetic radiation after transmission through the material contained therein.

One or both of the head portion and the probe portion may be contained within and protected by a suitable housing. The housing is designed to withstand the conditions in which the instrument may be deployed, including those of super-ambient temperature and pressure. At least the housing of the probe portion may include thermal insulation. A suitable thermal insulator has a thermal conductivity (K)<0.05 W/m/K, and especially <0.005 W/m/K. A temperature sensor may be provided to monitor the temperature at one or more locations within the enclosure.

Transmitted signals are caused to undergo an interaction mediated by the material at each window site. As previously described, interactions may be one or more of absorption, scattering, or reflection. One approach setting up a resonance condition at each window site, comparing the respective resonance frequencies, and drawing inferences therefrom regarding the material present at each of the respective window sites.

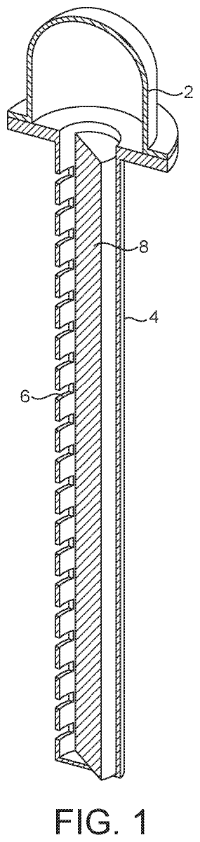

The instrument illustrated in FIG. 1, shown in cutaway schematic, has a housing 2 for an emitter (not shown) of microwave radiation, which is adapted to sit outside a vessel in use, and an elongate probe portion 4 which extends into the vessel and contents in use.

The probe portion 4 comprises an elongate cylindrical microwave wave guide defined by a conductive wave guide wall. Suitable materials for the conductive wave guide wall may include metals and for example copper, aluminium, or steel. The wave guide couples radiatively to the emitter to act to transfer emitted electromagnetic radiation along its length.

A longitudinally spaced array of wave guide slots 6 is provided in the conductive waveguide wall. Slotted guided radar antennas are traditionally used as marine antenna, to monitor traffic. These systems typically use a form of microwave as the electromagnetic radiation being emitted by the antenna. The present invention uses similar principles for its guided microwave probe.

When the waveguide probe 4 is inserted into a vessel containing multiple layers of substances from which profile information is required, the return signal produced by the signal from each slot 6 in the waveguide after an interaction with the material at the respective slot (for example transmission and/or reflection) can be studied to gain an understanding of the dielectric properties of the material at the respective slots, and from this profile information can be inferred.

Any suitable receiver arrangement may be provided in conjunction with the transmitter array defined by the slots in the guided microwave probe.

In the configuration illustrated in FIG. 1, the transmitter and receiver are disposed in a housing 2 at an end of the waveguide. However, in an alternative configuration, a second probe can be provided which comprises an array of receiving elements each corresponding in use to an emitting slot. Each receiving element then receives a separate microwave signal after interaction with the material outside the respective slot, which interaction has been mediated by the dielectric properties of the material. For example, the second probe may be spaced from the first in use so that each received signal is a signal mediated by transmission through the material, and hence subject to absorption.

One difference between the slotted waveguide configuration described herein and a standard marine antenna is that the interior of the waveguide in the present instrument must be protected from the external fluid which is being analysed, which might otherwise enter the waveguide and prevent it from working correctly. To prevent this the waveguide slots 6 can be provided with solid transparent windows and/or the waveguide can be filled with a material which is transparent to microwaves. FIG. 1 shows a ceramic waveguide 8 within the conductive waveguide walls of the of the waveguide probe 4.

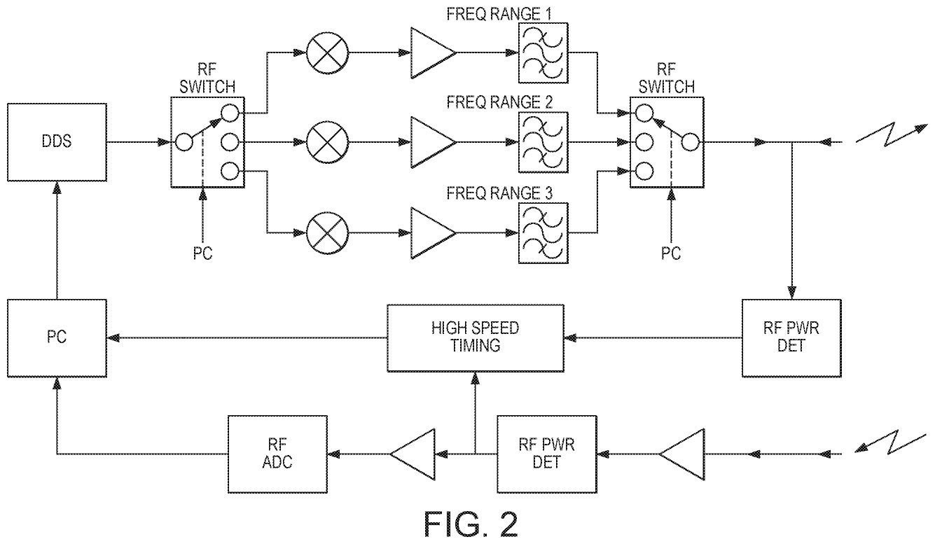

Return electromagnetic signals can be processed in various ways. The time from emission to reception of the signals may be used to determine the level of each received signal and to associate each received signal with a respective slot, allowing profile information to be inferred. A basic block diagram of a system configuration for a time-of-flight measurement system is shown in FIG. 2. Existing radiofrequency (RF) electronics building blocks can be used to construct a system that can generate, transmit, receive and measure the necessary RF signals for the system described herein. A commonly used building block in radar and communications systems is the ‘Direct Digital Synthesis’ (DDS) device that can directly construct a variety of highly pure and stable waveforms from low frequency though to RF. Available mixers can also be used to upconvert the DDS signal to whatever frequency is required. The DDS is also able to have the frequency characteristics of the output signal configured—single tone, frequency sweeps, and chirps (commonly used in radar) are all easily set up.

RF voltage/power measurement is easily achievable with standard off-the-shelf parts up to tens of gigahertz directly without down-conversion. These devices take an RF signal and generate a representative dc output signal that can be directly digitised for analysis. Ultrafast digital electronics can be used to construct a high-speed timing subsystem if time-of-flight measurements of the RF signal are utilized.

While this invention has been particularly shown and described with reference to certain embodiments, it will be understood to those skilled in the art that various changes in form and detail may be made without departing from the scope of the invention as defined by the appended claims.

1-12. (canceled)

13. A level measurement instrument comprising:
a transmitter configured to transmit an electromagnetic transmission signal, the electromagnetic transmission signal being a microwave signal or a radio wave signal;
a receiver configured to receive a plurality of electromagnetic return signals;
an elongate electromagnetic radiation guide coupled to the transmitter to guide the electromagnetic transmission signal;
wherein the elongate electromagnetic radiation guide is provided with a plurality of windows spaced along the elongate electromagnetic radiation guide, the windows being at least partially transmissive to the electromagnetic transmission signal such that in use, when the elongate electromagnetic radiation guide is introduced into a fluid column, the electromagnetic transmission signal interacts with fluid adjacent each window and generates electromagnetic return signals, the return signal from each window being dependent on a parameter of the fluid adjacent each window such that different fluids in the fluid column have different return signals, and
wherein the receiver is configured to differentiate between the electromagnetic return signals and thus determine a level of one or more fluids in the fluid column based on a difference in relative permittivity of different fluids in the fluid column.

14. The level measurement instrument according to claim 13,
wherein the elongate electromagnetic radiation guide is configured such that fluid does not enter the elongate electromagnetic radiation guide through the windows when the elongate electromagnetic radiation guide is introduced into a fluid column.

15. The level measurement instrument according to claim 14,
wherein the elongate electromagnetic radiation guide is formed of a tubular member through which the electromagnetic transmission signal is guided in use, and
the windows are sealed by a solid transmission material which is at least partially transparent to the electromagnetic transmission signal.

16. The level measurement instrument according to claim 15,
wherein the solid transmission material at least partially fills an interior of the elongate electromagnetic radiation guide.

17. The level measurement instrument according to claim 15,
wherein the tubular member is metallic and the solid transmission material is a glass or a ceramic.

18. The level measurement instrument according to claim 13,
wherein the windows are formed by slots in the elongate electromagnetic radiation guide thus providing a slotted wave guide.

19. The level measurement instrument according to claim 13,
wherein the transmitter is configured to transmit electromagnetic radiation having a frequency in a range 0.3 GHz to 300 GHz.

20. The level measurement instrument according to claim 19,
wherein the transmitter is configured to transmit electromagnetic radiation having a frequency in a range 2 GHz to 20 GHz.

21. The level measurement instrument according to claim 13,
wherein the transmitter and the receiver are disposed in a housing at one end of the elongate electromagnetic radiation guide.

22. The level measurement instrument according to claim 13,
wherein the receiver is disposed in a separate housing spaced apart from the elongate electromagnetic radiation guide.

23. A method of measuring a level of one or more fluids in a fluid column, the method comprising:
introducing the level measurement apparatus according to claim 13 into the fluid column such that the elongate electromagnetic radiation guide extends through the fluid column;
transmitting an electromagnetic transmission signal, the electromagnetic transmission signal being a microwave signal or a radio wave signal, through the elongate electromagnetic radiation guide such that the electromagnetic transmission signal interacts with fluid adjacent each window and generates electromagnetic return signals, the electromagnetic return signal from each window being dependent on a parameter of the fluid adjacent each window such that different fluids in the fluid column have different return signals;
receiving the electromagnetic return signals; and
processing the return signals to differentiate between the electromagnetic return signals from each of the windows and determine a level of one or more fluids in the fluid column based on a difference in relative permittivity of different fluids in the fluid column.

24. A system comprising a vessel for housing a fluid, and a level measurement instrument according to claim 13, the level measurement instrument being mounted such that the elongate electromagnetic radiation guide of the level measurement instrument extends through the vessel.
